(19) United States
(12) Patent Application Publication
(10) Pub. No.: US 2021/0374351 A1
(43) Pub. Date: Dec. 2, 2021

(54) SENTENCE VERIFICATION FOR STATISTICAL GRAPHS

(71) Applicant: The Government of the United States of America, as represented by the Secretary of the Navy, Arlington, VA (US)

(72) Inventors: Mark A. Livingston, Silver Spring, MD (US); Derek Brock, Arlington, VA (US); Jonathan W. Decker, Burtonsville, MD (US); Dennis J. Perzanowski, Burke, VA (US); Christopher Van Dolson, Alexandria, VA (US); Joseph Matthews, Laurel, MD (US); Alexander Lulushi, Oakton, VA (US)

(21) Appl. No.: 16/889,070

(22) Filed: Jun. 1, 2020

(51) Int. Cl. G06F 40/30; G06F 16/901; G06F 16/903

(52) U.S. Cl. CPC G06F 40/30; G06F 16/903; G06F 16/9024

(57) ABSTRACT

Systems and methods are provided for generating queries suitable for evaluating graph comprehension capability. Embodiments of the present disclosure are based on the Sentence Verification Technique (SVT), an empirically validated framework for measuring an individual's comprehension of prose material. Compared to ad hoc methods for testing graph comprehension, embodiments of the present disclosure are less subjective, require less manual effort and subject matter expertise, and address the essential features of a given graph: values and relationships depicted, frames of reference, and style attributes. Embodiments of the present disclosure combat superficial comprehension by testing what the reader has encoded, as opposed to testing the reader's ability at visual recall or ability to look up data without reaching real comprehension.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 107230-US2.

### FIELD OF THE DISCLOSURE

This disclosure relates to training, including automated training.

### BACKGROUND

In our information-driven society, there is increasing use of statistical graphics to convey information in a variety of settings, including industry, mass media, government operations, and health care. Current methods for assessing a reader's ability to comprehend statistical graphics are custom-written, not widely accepted, usable only once, and/or reliant on subjective interpretations and inferences.

Many applications require operators to make decisions that rely on their understanding of information displayed graphically (in charts, tables, graphs, or diagrams). Despite the ubiquity of statistical graphics, there is a standard neither for measuring their clarity and explanatory power, nor for assessing an operator's level of graphical comprehension abilities. In addition, operator displays are increasingly complex: multiple graphics each tell a part of the story, and interactive graphics are relied upon without evidence of their usability. Thus, there is a clear need to develop rigorous methods to determine whether a correct interpretation of statistical graphics can be expected, and whether an operator has the required skill to reach this understanding. Such methods would differentiate between confusing statistical graphics and inadequate training of an operator.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram of an example bar graph that is used to demonstrate query variations as they are adapted from sentences to graphs in accordance with an embodiment of the present disclosure;

FIG. 2 is a diagram of an example bar graph generated based on an original query in accordance with an embodiment of the present disclosure;

FIG. 3 is a diagram of an example bar graph generated based on a paraphrase query in accordance with an embodiment of the present disclosure;

FIG. 4 is a diagram of an example bar graph generated based on a meaning change query in accordance with an embodiment of the present disclosure;

FIG. 5 is a diagram of an example bar graph generated based on a distractor query in accordance with an embodiment of the present disclosure;

FIG. 6 is a block diagram of an exemplary system for determining graphical comprehension in accordance with an embodiment of the present disclosure; and

FIG. 7 is a flowchart of an exemplary method for determining graphical comprehension in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide systems and methods for generating queries suitable for evaluating graph comprehension capability. Embodiments of the present disclosure are based on the Sentence Verification Technique (SVT), an empirically validated framework for measuring an individual's comprehension of prose material. Compared to ad hoc methods for testing graph comprehension, embodiments of the present disclosure are less subjective, require less manual effort and subject matter expertise, and address the essential features of a given graph: values and relationships depicted, frames of reference, and style attributes. Embodiments of the present disclosure combat superficial comprehension by testing what the reader has encoded, as opposed to testing the reader's ability at visual recall or ability to look up data without reaching real comprehension.

Embodiments of the present disclosure can generate queries appropriate for testing comprehension (e.g., of statistical graphics). With a large corpus of queries, embodiments of the present disclosure can be used to test an individual's knowledge, skills, and abilities in reading statistical graphics. For example, with data acquired from numerous such tests, embodiments of the present disclosure can determine the likelihood that a particular statistical graphic will be read as intended by the designer by a given population of readers. With such queries and the difficulty ratings of the components, embodiments of the present disclosure can be used to write and/or implement a training regimen for improving knowledge, skills, and abilities of an individual (and/or a computer program, system, device, etc.) in reading statistical graphics.

Embodiments of the present disclosure can be used to test the ability of a user (or a program, device, etc.) to read and understand graphs. To do so, embodiments of the present disclosure provide questions that can reliably determine whether someone understood (and wasn't just answering based on general knowledge or a visual pattern match). Embodiments of the present disclosure use a successful, automated query generation method for reading comprehension. In an embodiment, successful means that it is validated not to be “beaten” by general knowledge or logical reasoning but tests the mental construct that is inherent to the definition of comprehension in the field of cognitive science.

Embodiments of the present disclosure use a specification of a graph and create queries that can test whether someone truly understood (i.e., internalized the information on) the graph by testing their memorial representation. In an embodiment, comprehension is not just being able to look up information accurately, such as seeing what y-value is indicated at given x-value or which x-value has the highest value.

For example, an analogy can be made between the concepts of literacy (communication through words), numeracy (communication of mathematical concepts), and graphicacy (communication through statistical graphics). A determination can be made regarding how to assess both literacy of individuals and readability of prose documents. Embodiments of the present disclosure provide a comprehensive evaluation procedure and can apply this to statistical graphics, with a focus on displays used for monitoring, analysis, and decision-making. This transactional information domain is a critical concern and involves a high volume of heterogeneous data which should be analyzed in a short time frame, making concerns about statistical graphics important in this domain. Embodiments of the present disclosure provide systems and methods for generating queries that will enable testing comprehension of statistical graphics.

Embodiments of the present disclosure provide a reliable and robust method of generating not just a single test of graph comprehension, but a large corpus of graph comprehension queries. Embodiments of the present disclosure can provide a battery of tests that can determine the parameters of a class of graphs that make an instance harder or easier to read. A series of tests could help an educator identify whether a particular individual has learned the skills necessary to read a particular type of graph. With a large base of results from such a test battery, a general level of skill required to successfully read a particular graph (akin to reading level or grade level of prose) could be assessed through the graph properties. A precise test battery could even help ascribe the resulting difficulty level to individual properties. Further, even test questions custom-written by experts in accordance with standard test procedures may not truly measure comprehension. Embodiments of the present disclosure are based on a reading comprehension assessment methodology designed to overcome this challenge as well.

In an embodiment, a system and/or method for generating queries operates on a specification of a statistical graphic in JavaScript Object Notation (JSON) within the High Charts specification grammar. This (including default values) gives a complete description of the appearance and data of a statistical graphic. In an embodiment, an algorithm for generating queries can be conceived of as a set of rules that may be applied to this specification to generate a variation of the original graphic within the definition of four query types of a Sentence Verification Technique (SVT). In an embodiment, these four types can include (1) original: a verbatim quote of information that appeared in the source; (2) paraphrase: a restated version of information that appeared in the source; (3) meaning change: an altered quote, in which one element is changed to contradict the source; and (4) distractor: an apparent quote, in which most or all of the information is new. It should be understood that embodiments of the present disclosure can use all four query types listed here, a single type of query, less than 4 queries, or additional queries not listed here. For example, in an embodiment, an SVT uses queries of types (2) and (3).

Embodiments of the present disclosure provide rules that can be used to permit, require, and/or prohibit combinations of changes. In an embodiment, these rules were implemented using Python computer code that takes a modified JSON description of the graph, along with an encoded “dictionary” of changes embedded in the JSON format. In an embodiment, the software reads this input and then produces the JSON description of all graphs that fit the rules, which are encoded in the software. These JSON files may then be passed to an application programming interface (API), such as the HighCharts API, to produce a visual representation of each graph in the set. The set of graphs then constitutes a legal set of queries that may be used in a graph comprehension test.

In an embodiment, the process is more automated and does not require writing the rules into a modified JSON description. For example, in an embodiment, one set of rules is used for any set of graphs that may be input, and a determination is made regarding which rules may be applied (e.g., by matching existing specification keywords and values to the rule). Embodiments of the present disclosure can balance the total number of times each rule is required, which can create a better balance to the overall set of graphs that are generated. This can give a better balance in a final test between different types of graph features that may be tested.

2. Exemplary Rules for Creating SVT Query Graphs from a Source Graph

In an embodiment, statistical graphics (SGs) are composed of four functional constituents: (1) background; (2) framework, which indicates what kinds of measurements are being used and what things are being measured; (3) content, which specifies particular relations among the things represented by the framework; and (4) labels, which allow constituents (particularly the scales) to be interpreted. In practice, a graph background is often a solid color (frequently white) or perhaps an image that carries some theme or message. The framework for a bar graph or line graph can include one or two axes at right angles to each other and the page or image boundary; for a radial graph, it may include a set of concentric circles. The content can include the lines, bars, point symbols, or other marks that connect values of the axes. Labels can include text, numbers, symbols (or other features) that name variables, levels within variables, values along the framework, the entire graph (or other features).

In an embodiment, in developing queries according to the sentence verification technique (SVT), what constitutes the words in a sentence in a graph is determined. In an embodiment, the four constituents discussed above are not the equivalent of prose sentences; they do not convey complete thoughts. In an embodiment, they convey entities, quantities, and concepts, as well as actions involving these. Thus, they can function akin to words in a sentence (e.g., nouns, verbs, adjectives, adverbs, and perhaps others).

In an embodiment, sentences in SGs are the meaningful informational statements or assertions that are coordinated, collectively, by the SG's graphical and textual constituents. These sentences can be built from the (equivalents of) words identified above. For example, a lone bar from a bar graph may not be an informational statement, but it can be when it is shown together with (at a minimum) a framework and labels. Two bars from the same graph can convey an abstract relationship but can fail to make a meaningful informational statement, unless their display is coordinated by the relevant elements of the SG's other constituents. By analogy, points and lines on line graphs can require a framework and labels to join them in the equivalent of a sentence.

Prose sentences can be simple or complex. An analogy for this in an SG is to think of the SG's information statements as assertions that can be combined. Unlike prose, wherein each sentence is a clearly delineated statement, which may be a simple assertion or a complex statement composed of multiple contributing statements, an SG's informational assertions may not be clearly delineated, with the exception of taking the whole SG as a statement. As an example, consider a bar graph with three bars. One may count each bar (together with the framework and relevant labels) as a simple statement; similarly, each combination of two bars, and the combination of all three, could be counted as compound statements. This is one schema among multiple possible schemas.

Embodiments of the present disclosure can set forth rules for each SVT query type that governs the range of possible alterations that define each query type. However, there are numerous subtle qualities of SGs that could be altered without changing the meaning of the SG. Navigating these features can be a key contribution to applying the SVT to SGs. Embodiments of the present disclosure can consider appearance parameters such as colors, line or border width (including zero width), texture or fill, font properties, etc., to be in the list of potential changes. This could be akin to changing the font properties or margin alignment for a paragraph of prose, for example.

### 2.1. Exemplary Rules for Original Query Type

In an embodiment, an original query type can be defined as “a verbatim copy of the sentence in the reading passage.” In an embodiment, content may have different colors, fill, shapes, etc. In an embodiment, labels may be drawn in different font family, size, or style and be centered differently. In an embodiment, the framework could theoretically be changed without altering the meaning, but this would necessarily change the syntax of the content.

In an embodiment, features of the SG that do not contribute to the correct interpretation of the meaning of the underlying data can be considered as not endemic to the SG. For example, if the bars in a bar graph are drawn as empty rectangles, it does not change the meaning of the graph—i.e., it does not alter the content, the framework to which that content is mapped, or the labels which make explicit the interpretation. Taking this step beyond the native definition can enable avoiding having the original query type become nothing more than a visual memory test. In queries of type original, non-data dimensions of the content of the SG can be altered: bar or line color, bar width, point marker type, bar or marker outlines, etc. Similarly, the font and size for labels does not change their meaning. In an embodiment, the placement of the content (directly derived from the underlying data), the wording of the labels, and the framework are not changed. Table 1 below shows exemplary permitted, mandatory, and prohibited changes to parameters in accordance with an embodiment of the present disclosure. In an embodiment, “permitted,” “mandatory,” and “prohibited” in Table 1 (and in Tables 2 and 3) can be defined as follows. In an embodiment, “permitted” means that changes can be made but are not required. In an embodiment, “mandatory” means that at least one change must be made along the options in the “mandatory” row (for example, at least one change to “content” or at least one change to “labels”). In an embodiment, “prohibited” means no changes of the type listed in the table are permitted.

TABLE 1

| | Content | Framework | Labels |
|---|---|---|---|
| Permitted | changes to appearance | no changes | changes to appearance |
| | parameters | | parameters |
| Mandatory | some changes to | no changes | some changes to |
| | appearance parameters | | appearance parameters |
| Prohibited | changes to placement | any changes | changes to words |

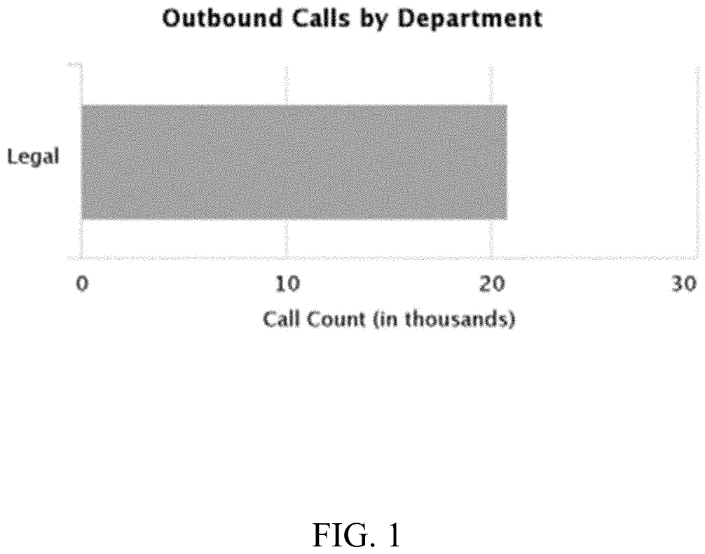

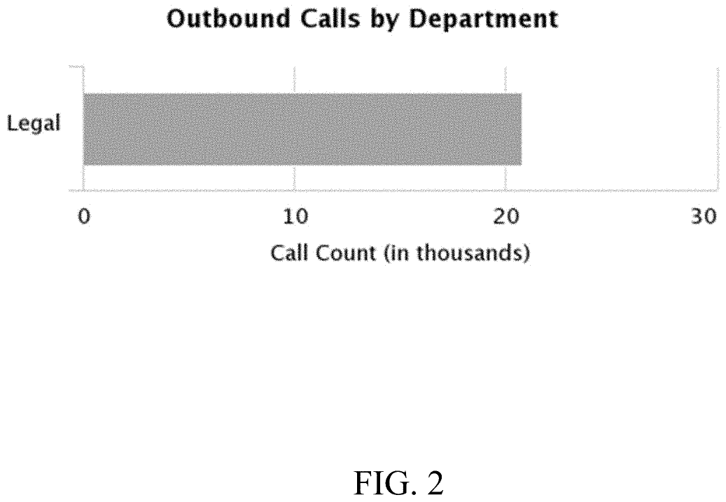

FIG. 1 is a diagram of an example bar graph that is used to demonstrate query variations as they are adapted from sentences to graphs in accordance with an embodiment of the present disclosure. FIG. 2 is a diagram of an example bar graph generated based on an original query in accordance with an embodiment of the present disclosure.

### 2.2. Exemplary Rules for Paraphrase Query Type

In an embodiment, a paraphrase query type calls for “as many words as possible to be changed without altering the meaning or the syntactical structure of” the original. Thus, in an embodiment, all changes permitted in an original query are also permitted in a paraphrase query; as discussed above, none of these changes would change the meaning, so they fit both definitions. However, in an embodiment, a paraphrase is not “a verbatim copy,” since that definition belongs to the original query type. Therefore, a paraphrase could also make changes to the wording of labels.

In an embodiment, style changes to content are the same as for original queries. In an embodiment, rounding is acceptable (so long as it moves the content by amounts that do not confuse the value). In an embodiment, smoothing data is acceptable. In an embodiment, labels may still have different style; however, a paraphrase could also change the wording of labels when possible, using synonyms, standard abbreviations (e.g., Sun., Mon., Tue., or Jan., Feb., etc.), different units for numbers (e.g., converting to scientific notation, or giving numbers in thousands), etc. In an embodiment, subjective judgments can be made about equivalence of the words substituted into labels. As with the application of the SVT to prose, a thesaurus or word distance library such as WordNet, may mitigate this challenge, although the jargon associated with the domain of a graph could create additional complexity. However, with the wide use of statistical graphics, domain-specific issues can be avoided without limiting the range of style attributes explored in a test. In an embodiment, changes to the wording of labels can include synonyms to words or changes to representations of numbers (e.g., converting to scientific notation, or labeling the entire axis as representing numbers in thousands and dropping three zeros from values).

Considering the framework, we observe that many changes to the framework do not change the meaning ascribed to the content. The framework includes the number of major units and minor units (e.g., denoted by gridlines and/or tick marks). Changes in these values do not alter the interpretation of the data, although they may make it easier or harder to discern. In an embodiment, more drastic changes to the framework without changing the meaning of a graph could be made. Changes to the structure of the graph, such as transposing the graph, conversion to or from logarithmic axes, and changes to the range of an axis, can be performed or not performed in accordance with embodiments of the present disclosure. In an embodiment, changes to the structure of the graph are not performed because such changes can alter the syntax of the graph.

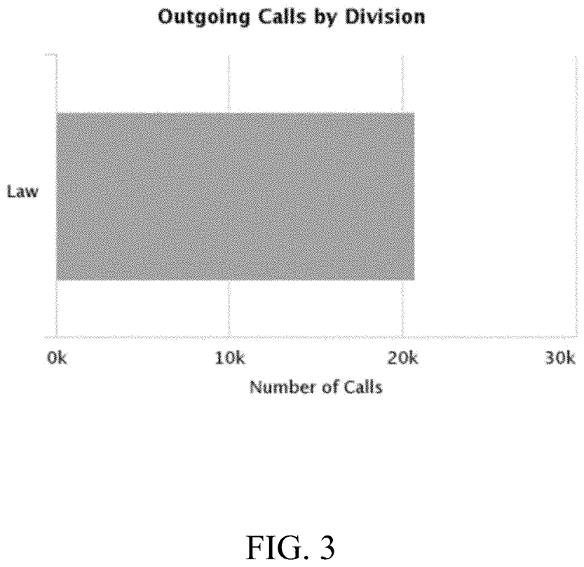

Embodiments of the present disclosure can include possible changes to the content. For example, approximations to line graphs can be formed by smoothing of the underlying data. In an embodiment, the changes are designated to be below a (predetermined or computed) threshold that could be noticed, akin to a just-noticeable difference (JND). As an example of the complexity of applying the JND obtained on a blank canvas, we reasoned that the presence (or absence) of gridlines on a bar or line graph would certainly change the status of differences in lengths to (or from) noticeable. Table 2 below shows exemplary permitted, mandatory, and prohibited changes to parameters in accordance with an embodiment of the present disclosure. FIG. 3 is a diagram of an example bar graph generated based on a paraphrase query in accordance with an embodiment of the present disclosure.

TABLE 2

| | Content | Framework | Labels |
|---|---|---|---|
| Permitted | changes to | use and number | changes to appearance |
| | appearance | of gridlines | parameters, changes |
| | parameters, | and tick marks, | to synonyms of label |
| | rounding, | changes to unit | words, changes to |
| | smoothing | representations | unit representation |
| | | that convey | in numerical labels |
| | | equivalent | |
| | | meaning | |
| Mandatory | some changes | no changes | some changes to |
| | to appearance | | appearance parameters, |
| | parameters | | some changes to label |
| | | | and word choices |
| Prohibited | changes that | exchange of axes | changes to words |
| | noticeably | (transposing the | beyond synonyms, |
| | alter content | graph), changing | changes to numerical |
| | mappings | axis range, | values |
| | (crossing, | changing axis to/ | |
| | gridlines, | from logarithmic | |
| | aligning to | | |
| | gridlines, | | |
| | etc.) | | |

### 2.3. Exemplary Rules for Meaning Change

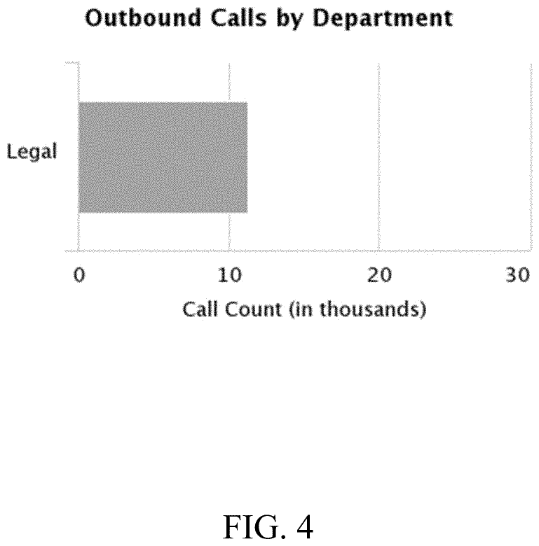

In an embodiment, the rule for a meaning change is to “alter one word in an original sentence such that the meaning of the sentence is changed.” Since, in an embodiment, we adopt the paradigm that the “words” of an SG are the constituents in the content, framework, and labels, it follows that we should change one of these in a way that alters the meaning, and that no further changes (even those that do not change meaning) may be permitted. In an embodiment, style changes to these three components are still permitted. Possible ways to change meaning include noticeable change to a datum (content), changes to labels, or changes to the framework. In an embodiment, multiple data changes to maintain a trend may be permitted. In an embodiment, these changes cannot include the introduction of unrelated categories or series of data, since the introduction of new material belongs to the distractor query type. The library of possible changes is apparent from the discussion regarding the paraphrase query type. FIG. 4 is a diagram of an example bar graph generated based on a meaning change query in accordance with an embodiment of the present disclosure.

### 2.4. Exemplary Rules for Distractor Query Type

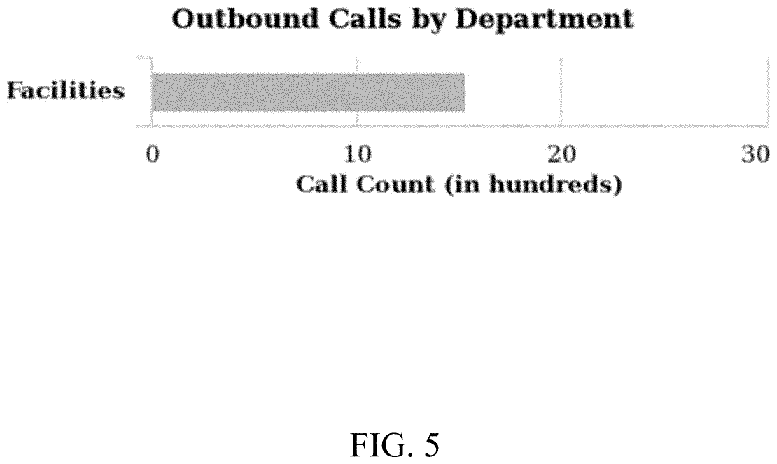

In an embodiment, the definition of a distractor query is “a sentence that is consistent with the general theme of the source material but is unrelated to any original sentence; it should also have the same length, syntactical structure, and conceptual complexity as sentences in the source material.” This tells us that we should make multiple changes of the type we may make for a meaning change. However, in an embodiment, changes are limited to changes that stay within the topic of the source graph. Table 3 below shows exemplary permitted, mandatory, and prohibited changes to parameters in accordance with an embodiment of the present disclosure. FIG. 5 is a diagram of an example bar graph generated based on a distractor query in accordance with an embodiment of the present disclosure.

TABLE 3

| | Content | Framework | Labels |
|---|---|---|---|
| Permitted | changes to a data | changes to an | change a label |
| | value, appearance | axis range or | beyond a |
| | parameters | scaling | synonym |
| Mandatory | multiple changes | multiple changes | multiple changes |
| | listed as permitted | listed as | listed as |
| | for any constituent | permitted for | permitted for any |
| | | any constituent | constituent |
| Prohibited | moving data far | n/a | changing all |
| | outside the original | | labels beyond |
| | range of the data | | synonyms |

### 3. Exemplary Test of Queries

To build materials for a pilot test, we constructed nine source bar graphs and nine source line graphs. For each graph, we wrote a JSON specification for HighCharts. We then applied the rules to create the four SVT query types (original, paraphrase, meaning change, and distractor). Finally, we rendered images of all graphs using HighCharts. We wrote web pages to present the instructions, source graphs, and queries, as well as two diversionary tasks, described next. Of the nine graphs of each type (bar and line), one was embedded in the instructions, two were used for practice, and six were used for testing.

To reduce reliance on visual memory, we added two diversionary tasks. We showed participants two images in sequence, each for three seconds. These were intended to interrupt visual pattern memory and were taken from a public database for eye tracking data; they showed a variety of natural and urban imagery, with a few close-up images of common items (e.g. flowers, a sneaker). Participants also read brief, successive excerpts (about 200 words) from an out-of-copyright novella. For each trial, participants were asked to study a graph and a prose excerpt (as sources) and to answer corresponding queries; they were asked simply to look at the diversionary images for whatever they found interesting. The prose also gave us a baseline for comparison against the graph comprehension task. Thus, the complete sequence of a data trial was (1) show a source graph (minimum time: 30 sec, maximum time: 3 min); (2) show a diversion image (3 sec); (3) show a blank screen (1 sec); (4) show a second diversion image (3 sec); (5) show a blank screen (1 sec); (6) show a source prose excerpt (also 30 sec to 3 min); (7) show a graph query and ask the participant whether the information in this graph query was “stated” or “not stated” in the previous source graph; and (8) show a prose query and ask the participant whether the information in this prose query was “stated” or “not stated” in the previous source prose.

Participants completed a pre-study questionnaire with demographic and background information. They next read four pages with instructions for the task: (1) examples of the SVT on prose, (2) our adaptation with a bar graph example, (3) our adaptation with a line graph example, and (4) a brief summary of the procedure. They next completed four practice trials of the above sequence. During this practice, the above sequence was followed by two screens: one for giving the correct answer for the graph query (confirming that the participant was correct or informing the participant of the correct answer), and one for giving the correct answer for the prose query (again, with confirmation or correction). After the practice, a short break was permitted and the participant was asked if he or she had any questions about the procedure.

Then the twelve trials were conducted, grouped by graph type (bar or line). Half the participants saw the six bar graph trials as their first group; the other half saw the line graphs first. Within each group, a Latin square ordered the graphs and another Latin square ordered the SVT query types. After the first group of queries, another break was permitted; no participants took a break for more than a few seconds. Twenty-four participants (20 male, 4 female) completed the study; they ranged in age from 19 to 58 (mean and median age were both 38). All self-reported having normal or corrected-to-normal visual acuity and normal color vision. All but one of our participants also reported being heavy computer users; ten reported that they closely read bar graphs or line graphs for work or personal reasons on at least a weekly basis. Thirteen said that they create such graphs for work or personal projects. Our participants came from the research and clerical staff at our laboratory; fourteen held a graduate degree. For the procedure as described above, participants took an average of 54 minutes (minimum 31 min, maximum 98 min).

Overall, participants got 92.0% correct on graph queries; they got 82.6% correct on prose queries. We conducted a series of one-way analysis of variance (ANOVA) tests with Greenhouse-Geisser correction to look for statistically significant differences. We found a main effect of SVT query type on response time, for both the graph queries and the prose queries.

Participants spent more time studying source graphs that had more data points on them, summed over all series, so we feel confident that our participants focused on the task they were attempting to complete. However, the number of points on the source graph did not show a main effect on accuracy. While our graph sources had between three and six data values, our graph queries contained one, two, or three data values. (One query showed all three of the source data values.) We noticed a slight tendency for participants to be more accurate as queries showed more data values. There was no significant main effect of sequence number on error. So, we did not find that the length of the study session limited the performance of our participants.

### 4. Discussion

Embodiments of the present disclosure provide a foundation for developing reliable and robust graph comprehension tests. By combining the SVT structure with graph specification languages and a taxonomy of graph components, embodiments of the present disclosure can systematically vary graphs within the boundaries defined by the SVT. The taxonomy for graph components provided by embodiments of the present disclosure enables a mostly objective construction for a comprehension query. Using the specification language, embodiments of the present disclosure can transform a source graph into any of the query graph types using text language processing rather than graph image processing.

As stated above, embodiments of the present disclosure provide systems and methods for generating tests of graph comprehension. To that end, embodiments of the present disclosure can use an SVT or procedure derived from the SVT, select a graph specification that fits the purposes of a specific application, and develop a database of rules or apply an existing database of rules for generating queries of each type mandated by the SVT.

Furthermore, we conducted a pilot study with the goal of showing that the visual form of the SVT was functional (that participants understood the task and that queries were generally found to be reasonable). Subjectively, we found that readers generally believed that they understood the task in the resulting graph comprehension test, and they objectively demonstrated comprehension of the graphs.

Embodiments of the present disclosure provide a reliable and algorithmic method through which we tests of comprehension of statistical graphics can be generated. There are numerous obvious extensions to embodiments of the present disclosure. Bar, column, and line graphs are discussed above because they are frequently used, other types of statistical graphics (e.g., pie graphs, scatterplots, etc.) can be used in accordance with embodiments of the present disclosure.

### 5. Exemplary Systems

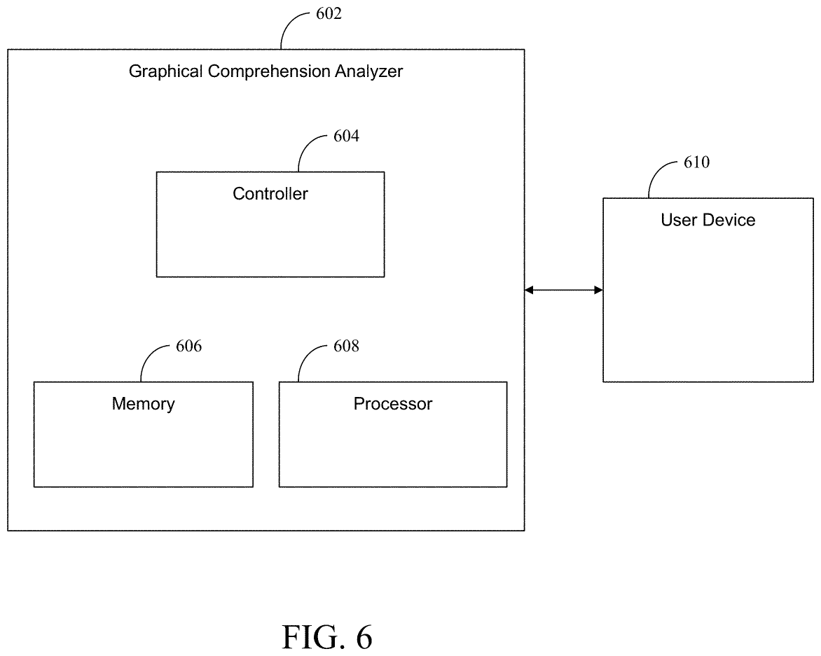

FIG. 6 is a block diagram of an exemplary system for determining graphical comprehension in accordance with an embodiment of the present disclosure. In FIG. 6, a graphical comprehension analyzer (GCA) 602 includes a controller 604, a processor 606, and a memory 608. In FIG. 6, GCA 602 communicates (e.g., over a wired or wireless link) with user device 610. While one user device 610 is shown in 610, it should be understood that GCA 602 can communicate with a plurality of user devices (e.g., to test graphical comprehension of a plurality of users) in accordance with embodiments of the present disclosure.

GCA 602 can be implemented using hardware, software, and/or a combination of hardware and software. GCA 602 can be implemented using a single device or multiple devices. GCA 602 can be implemented using a single piece of software, multiple pieces of software, and/or one or more pieces of hardware and software working in combination. For example, in an embodiment, GCA 602 can be implemented using a single piece of hardware and/or software that takes input graph specifications and outputs questions and another piece of hardware and/or software than selects questions to send to a (e.g., user device 610) and receives responses from the user.

In an embodiment, GCA 602 is implemented as software executing on a host device, such as a host computer. In an embodiment, memory 606 and/or processor 608 are not part of GCA 602 but are rather part of a host device, and GCA 602 accesses memory 606 and/or processor 608 in the host device. In an embodiment, GCA 602 is implemented using a standalone special purpose device for graphical comprehension analysis.

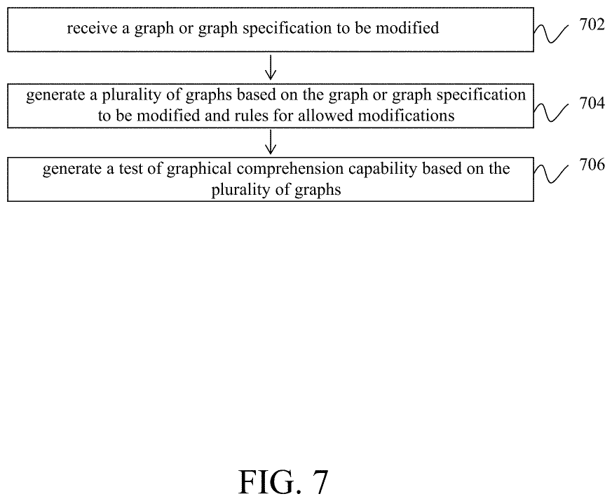

In an embodiment, user device 610 is a user device of a human user (such as a computer configured to display and receive information from a human user), and GCA 602 tests graphical comprehension of user device 610. In an embodiment, GCA 602 can be used to test graphical comprehension of user device 610 without input from a human user of user device 610. For example, in an embodiment, GCA 602 can be used to test graphical comprehension of an artificial intelligence (AI) and/or other program executing on user device 610. Exemplary operations performed by GCA 602 for determining graphical comprehension will now be described with reference to FIG. 7.

### 6. Exemplary Methods

FIG. 7 is a flowchart of an exemplary method for determining graphical comprehension in accordance with an embodiment of the present disclosure. In step 702, a graph or graph specification to be modified is received. For example, in an embodiment, GCA 602 receives one or more graphs or graph specifications to be modified. For example, in an embodiment, GCA 602 receives a graph or graph specification to be modified from a user. In an embodiment, the graph or graph specification to be modified is not received from a user but rather is stored in memory (e.g., in memory 606 and/or another memory accessible by GCA 602, such as a memory of a host device or a memory accessible over a network in communication with GCA 602).

In step 704, a plurality of graphs are generated based on the graph or graph specification to be modified and rules for allowed modifications. For example, in an embodiment, GCA 602 generates a plurality of graphs based on rules for allowed modifications. In an embodiment, GCA 602 receives a graph specification to be modified, generates a plurality of graph specifications based on the rules, and generates a plurality of graphs based on the plurality of graph specifications. In an embodiment, GCA 602 receives a graph to be modified and generates a plurality of graphs based on the rules.

In an embodiment, the rules for allowed modifications include rules for generating graphs based on the original, paraphrase, meaning change, and distractor queries described above). In an embodiment, these rules are stored in memory 606 and/or another memory accessible by GCA 602. In an embodiment, GCA 602 can also store (e.g., in memory 606 and/or another memory accessible by GCA 602) a set of changes previously enacted so that duplicate graphs are not generated or so that the rules are invoked an equal number of times or other desired distribution of times. In an embodiment, GCA 602 can look up text considered to be similar to generate the plurality of graphs (e.g., using a thesaurus stored in memory 606, another memory accessible by GCA 602, and/or in a memory of a device accessible via a network in communication with GCA 602, such as the Internet). In an embodiment, GCA 602 can be configured (e.g., based on the rules and/or other instructions) to use a balanced number of query types and difficulty levels for use when generating the plurality of graphs.

In optional step 706, a test of graphical comprehension capability is generated based on the plurality of graphs. For example, in an embodiment, GCA 602 can generate a test using the plurality of generated graphs and can send the test to user device 610 to test the graphical comprehension of user device 610 or of a human user of user device 610. In an embodiment, GCA 602 can be configured (e.g., based on the rules and/or other instructions) to select graphs representing a balanced number of query types and difficulty levels for use when generating the test. In an embodiment, a difficulty level can be configured (e.g., by a human user of GCA 602), and GCA 602 can design the test based on the difficulty level. In an embodiment, GCA 602 can transmit and/or display the plurality of graphs to a human user, program, and/or device before the plurality of graphs and/or test are transmitted to user device 610. In an embodiment, GCA 602 can receive modifications from a human user, program, and/or device before the graphs and/or test are transmitted to user device 610.

It should be understood that, in an embodiment, GCA 602 can receive multiple graphs and/or graph specifications to be modified and can generate a plurality of graphs based on these multiple graphs and/or graph specifications. In an embodiment, GCA 602 can generate one or more tests based on these generated graphs. For example, in an embodiment, GCA 602 can generate tests including a set of questions including subsets of questions that are each derived from respective graphs.

In an embodiment, GCA 602 can receive feedback from user device 610. In an embodiment, based on the feedback, GCA 602 can determine how accurately the human user and/or software of user device 610 comprehended the graphs transmitted to user device 610. For example, in an embodiment, GCA 602 can receive feedback from user device 610 indicating that a human or AI user of user device 610 correctly analyzed 90% of the graphs in the test sent to user device 610. In an embodiment, GCA 602 can determine which graphs were incorrectly analyzed and can store and/or transmit this information to a human user or AI of GCA 602. In an embodiment, this information can be used to train the human and/or AI user of user device 610 how to better analyze graphical information. In an embodiment, GCA 602 can determine the queries, difficulty levels, and/or changes made to a base graph to generate the graphs associated with the erroneous analysis and can generate similar graphs to test the human user and/or AI of user device 610 (e.g., to determine whether progress has been made in correctly analyzing graphs of these types).

In an embodiment, GCA 602 can generate families of queries (e.g., based on queries known to result in incorrect analysis when used in the generation of a test). For example, in an embodiment, GCA 602 can test the same family of modifications on different graphs. In an embodiment, GCA 602 can log information from tests for a plurality of users to determine which graph features, queries, families, etc. lead to greater error rates. In an embodiment, GCA 602 can analyze error information with user demographic data (e.g., education level) to determine classes of users that have trouble with specific graph features. In an embodiment, step 706 is optional—in an embodiment, GCA 602 can be configured to generate a plurality of graphs and can transmit these graphs to another device and/or program for later use (e.g., later testing).

### 7. Exemplary Advantages

Embodiments of the present disclosure use a well-defined, limited-vocabulary language that enables a rich graph-drawing program. Embodiments of the present disclosure can manipulate an instance of a graph specification in that language via standard text processing techniques. By combining the above techniques, embodiments of the present disclosure can generate comprehension queries for statistical graphics in a semi-automated manner. Embodiments of the present disclosure enable easier generation of comprehension queries for statistical graphics. Embodiments of the present disclosure further enable a greater range of comparisons for the difficulty for comprehension of varied aspects of graphs. Currently, it is challenging to meaningfully compare, for example, how much easier a graph would be to read with a change to a colormap versus a change to the axes. Embodiments of the present disclosure help to unify all such style and data issues.

Embodiments of the present disclosure generate queries that are better at assessing comprehension than current tests. Embodiments of the present disclosure generate queries that are more objective and thus less subject to bias (i.e., avoiding a problem for which standardized tests are often criticized). Embodiments of the present disclosure can generate a family of queries (i.e., effort for query writing is reduced and amortized). Embodiments of the present disclosure offer automated query generation (from graphs selected as “reading passages”), and a test author can still edit these automatically-generated queries. Embodiments of the present disclosure reduce subjectivity in writing response choices (or in grading free responses). Embodiments of the present disclosure enable test and re-test (as opposed to a static test) through a family of queries (e.g., the same class of modifications can be tested on different graphs). Embodiments of the present disclosure enable collection of data on which graph features lead to greater error rates.

### 8. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A method, comprising:
receiving, using a graphical comprehension analyzer (GCA) device, a graph or graph specification to be modified;
generating, using the GCA device, a plurality of graphs based on the graph or graph specification to be modified and rules for allowed modifications; and
generating a test of graphical comprehension capability based on the plurality of graphs.

2. The method of claim 1, wherein generating the plurality of graphs further comprises:
generating a first graph in the plurality of graphs using a verbatim quote of information that appeared in the graph or graph specification to be modified.

3. The method of claim 1, wherein generating the plurality of graphs further comprises:
generating a first graph in the plurality of graphs using a restated version of information that appeared in the graph or graph specification to be modified.

4. The method of claim 1, wherein generating the plurality of graphs further comprises:
generating a first graph in the plurality of graphs using changed information that contradicts a quote of information that appeared in the graph or graph specification to be modified.

5. The method of claim 1, wherein generating the plurality of graphs further comprises:
generating a first graph in the plurality of graphs using changed information that is different from a quote of information that appeared in the graph or graph specification to be modified.

6. The method of claim 1, wherein generating the plurality of graphs further comprises:
generating a first graph in the plurality of graphs using a verbatim quote of information that appeared in the graph or graph specification to be modified;
generating a second graph in the plurality of graphs using a restated version of information that appeared in the graph or graph specification to be modified;
generating a third graph in the plurality of graphs using changed information that contradicts a quote of information that appeared in the graph or graph specification to be modified; and
generating a fourth graph in the plurality of graphs using changed information that is different from a quote of information that appeared in the graph or graph specification to be modified.

7. The method of claim 1, wherein generating a test of graphical comprehension capability further comprises generating the test using a plurality of query types and difficulty levels.

8. The method of claim 1, further comprising:
sending the test to a user device;
receiving feedback from the user device based on the test; and
determining accuracy of the user device based on the feedback.

9. The method of claim 1, further comprising:
receiving a plurality of modifications to the plurality of graphs prior to generating the test.

10. A method, comprising:
receiving, using a graphical comprehension analyzer (GCA) device, a graph or graph specification to be modified;
generating, using the GCA device, a plurality of graphs based on the graph or graph specification to be modified and rules for allowed modifications, wherein generating the plurality of graphs comprises:
generating a first graph in the plurality of graphs using a verbatim quote of information that appeared in the graph or graph specification to be modified,
generating a second graph in the plurality of graphs using a restated version of information that appeared in the graph or graph specification to be modified,
generating a third graph in the plurality of graphs using changed information that contradicts a quote of information that appeared in the graph or graph specification to be modified, and
generating a fourth graph in the plurality of graphs using changed information that is different from a quote of information that appeared in the graph or graph specification to be modified; and
generating a test of graphical comprehension capability based on the plurality of graphs.

11. The method of claim 10, further comprising:
sending the test to a user device;
receiving feedback from the user device based on the test; and
determining accuracy of the user device based on the feedback.

12. The method of claim 11, wherein determining accuracy of the user device further comprises determining a first accuracy of the user device for the first graph, a second accuracy of the user device for the second graph, a third accuracy of the user device for the third graph, and a fourth accuracy of the user device for the fourth graph.

13. The method of claim 12, further comprising:
generating a second test of graphical comprehension capability based on the first accuracy, the second accuracy, the third accuracy, and the fourth accuracy.

14. A graphical comprehension analyzer (GCA), comprising:
a memory; and
a controller, wherein the controller is configured to:
receive a graph or graph specification to be modified,
generate a plurality of graphs based on the graph or graph specification to be modified and rules for allowed modifications, and
generate a test of graphical comprehension capability based on the plurality of graphs.

15. The GCA of claim 14, wherein the controller is further configured to:
generate a first graph in the plurality of graphs using a verbatim quote of information that appeared in the graph or graph specification to be modified.

16. The method of claim 14, wherein the controller is further configured to:
generate a first graph in the plurality of graphs using a restated version of information that appeared in the graph or graph specification to be modified.

17. The method of claim 14, wherein the controller is further configured to:
generate a first graph in the plurality of graphs using changed information that contradicts a quote of information that appeared in the graph or graph specification to be modified.

18. The method of claim 14, wherein the controller is further configured to:
generate a first graph in the plurality of graphs using changed information that is different from a quote of information that appeared in the graph or graph specification to be modified.

19. The method of claim 14, wherein the controller is further configured to:
generate a first graph in the plurality of graphs using a verbatim quote of information that appeared in the graph or graph specification to be modified;
generate a second graph in the plurality of graphs using a restated version of information that appeared in the graph or graph specification to be modified;
generate a third graph in the plurality of graphs using changed information that contradicts a quote of information that appeared in the graph or graph specification to be modified; and
generate a fourth graph in the plurality of graphs using changed information that is different from a quote of information that appeared in the graph or graph specification to be modified.

20. The method of claim 14, wherein the controller is further configured to:
send the test to a user device;
receive feedback from the user device based on the test; and
determine accuracy of the user device based on the feedback.
